(19) United States
(12) Patent Application Publication
(10) Pub. No.: US 2011/0123124 A1
(43) Pub. Date: May 26, 2011

(54) METHOD AND APPARATUS FOR GENERATING AN IMAGE COLLECTION

(75) Inventor: Marc Andre Peters, Eindhoven (NL)

(73) Assignee: KONINKLIJKE PHILIPS ELECTRONICS N.V., EINDHOVEN (NL)

(21) Appl. No.: 13/055,551

(22) PCT Filed: Jul. 15, 2009
(86) PCT No.: PCT/IB2009/053066

§ 371 Date: Jan. 24, 2011

(30) Foreign Application Priority Data
Jul. 29, 2008 (EP) 08161334.1

(51) Int. Cl. G06K 9/62

(52) U.S. Cl. 382/225

(57) ABSTRACT

A method of generating an image collection is described. A plurality of images are retrieved (step 202) and the images are divided into clusters according to a predetermined characteristic of the content of the images (step 204). At least one of the clusters is selected based on a number of images in each cluster (step 206). For each selected cluster, at least one image is selected on the basis of a predetermined criterion (step 208) and an image collection 5 comprising the selected images is generated (step 210).

### FIELD OF THE INVENTION

The present invention relates to a method and apparatus for generating an image collection.

### BACKGROUND TO THE INVENTION

The advances in digital imaging technology mean that digital cameras have become increasingly popular with consumers. As a result, an ever increasing number of digital still images are being captured and stored on computers or other storage media.

Some people now share their stored digital still images with others using a computer screen or television. However, this method of sharing photos is quite different to the traditional method of sharing actual printed photographs in a book.

It is therefore not surprising that creating a digital photo book and having it printed as a book has become an increasingly popular method of sharing images. The problem that exists with this method is that it takes a reasonable amount of effort and creativity to create such a book. For example, one has to choose which photos to select, how to display them, which background to use etc and one may additionally want to create annotations or other textual descriptions to display with the photos, which can be time consuming. This amount of effort and creativity that it requires makes people less likely to want to start making such books, or results in them stopping in the middle of the process of making one.

It is therefore beneficial for the user to be presented with an automatically generated image collection. An example of a method for automatically generating photo album pages is disclosed in U.S. Pat. No. 7,362,919. U.S. Pat. No. 7,362,919 describes a method for generating photo album pages in which images are grouped into one or more sets (e.g. grouping by event and/or by people present in the images) and in which designs appropriate for the image sets are chosen. A user selects which sets to include in the album. The layout of album pages is chosen based on image quality and composition.

However, this method still requires the user to decide which groups of images they want included in the album, which can be time consuming if there are, for example, a large number of groups of images.

It would therefore be very beneficial if the user could be presented with a fully automatically generated image collection to aid the user in sharing images.

### SUMMARY OF INVENTION

The present invention seeks to provide a method whereby an image collection, which is visually appealing to the user, is generated fully automatically.

This is achieved, according to one aspect of the present invention, by a method of generating an image collection, the image collection comprising a plurality of images, the method comprising the steps of: retrieving a plurality of images; dividing the images into clusters according to a predetermined characteristic of the content of the images; selecting at least one of the clusters based on a number of images in each cluster; for each selected cluster, selecting at least one image on the basis of a predetermined criterion; and generating an image collection comprising the selected images. The selected image collection may be a photo album or a slide show, for example.

This is also achieved, according to a second aspect of the present invention, by apparatus for generating an image collection, the image collection comprising a plurality of images, the apparatus comprising: retrieving means for retrieving a plurality of images; a divider for dividing the images into clusters according to a predetermined characteristic of the content of the images; a selector for selecting at least one of the clusters based on a number of images in each cluster and for selecting at least one image on the basis of a predetermined criterion for each selected cluster; and a display for generating an image collection comprising the selected images.

In this way, an image collection is generated fully automatically without the need for any interaction from the user thus providing a quick and effective way of presenting images. By automating the step of selecting, the user does not need to spend time browsing each of the sets of images to decide which images to include in the collection.

The step of dividing the images into clusters may comprise clustering images that have similar characteristics.

In this way, images of the same object or subject are clustered together thus automatically arranging the images into similar groups.

The step of selecting at least one of the clusters may comprise selecting clusters having the largest number of images.

By selecting clusters having the largest number of images, the images are more likely to be of interest to a user. This is because a user is likely to take more images of objects or events that the user is interested in and so by selecting the cluster having the largest number of images, the images that are of the most interest to the user are selected. This automatically and accurately distinguishes interesting images from less interesting images.

The step of selecting at least one of the clusters may comprise selecting a predetermined number of clusters having the largest number of images.

This allows the user to customize the selection if required since the predetermined number of clusters may be a number chosen by a user. By choosing the number of clusters, the user is able to customize the size of the image collection.

Alternatively, the step of selecting at least one of the clusters may comprise selecting a number of clusters having the largest number of images, the number of clusters being based on a distribution of numbers of images in each cluster.

In this way, if there are a greater number of large clusters, it is possible for more of them to be selected thus ensuring that all images that are likely to be of interest to the user are selected. The image collection can therefore be adapted depending on the number of largest clusters and therefore the number of images that are likely to be of interest to a user.

The step of selecting at least one image on the basis of a predetermined criterion may comprise selecting a number of images from each cluster, the number of images being determined on the basis of the variation within the cluster.

This means that the most desirable images will be selected since the images within the same cluster whose characteristics vary the most are more likely to be different thus avoiding the possibility of selecting images that are almost exactly the same.

Alternatively, or in addition, the step of selecting at least one image on the basis of a predetermined criterion may comprise selecting a number of images from each cluster, the number of images being determined on the basis of the number of images in the cluster.

In this way, the number of images selected can be adapted depending on the total number of images within a cluster. Therefore, if a user takes many images of an object/event, it is possible to include several of them in the image collection rather than a single one.

For example, if one image is selected, the step of selecting at least one image may comprise selecting the image closest to a centroid of the cluster. Alternatively, if more than one image is selected, the step of selecting at least one image may comprise selecting at least one pair of images that are furthest apart. This may be based on, for example, a distance measurement such that images that are dissimilar (i.e. that differ the most) are selected.

In this way, the images that are selected are most likely to be different and therefore more desirable to the user.

The step of generating an image collection comprising the selected images may comprise generating an image collection comprising a plurality of pages, each page comprising at least one of the selected images.

This presents the image collection to a user in a way that is simple yet effective. The image collection resembles a book of images allowing the user to easily and effectively browse the images in the collection.

The plurality of pages may be ordered based on features extracted from the images included on each page.

This provides a reference for the user such that the user can find images easily and need not scroll through a large number of images to find the image that they require.

The method may further comprise generating a background based on information extracted from the selected images.

In this way, the image collection is visually appealing to the user and also personalized to the images within the collection.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for generating an image collection; and

FIG. 2 is a flowchart of a method of generating an image collection.

### DETAILED DESCRIPTION OF EMBODIMENTS OF THE INVENTION

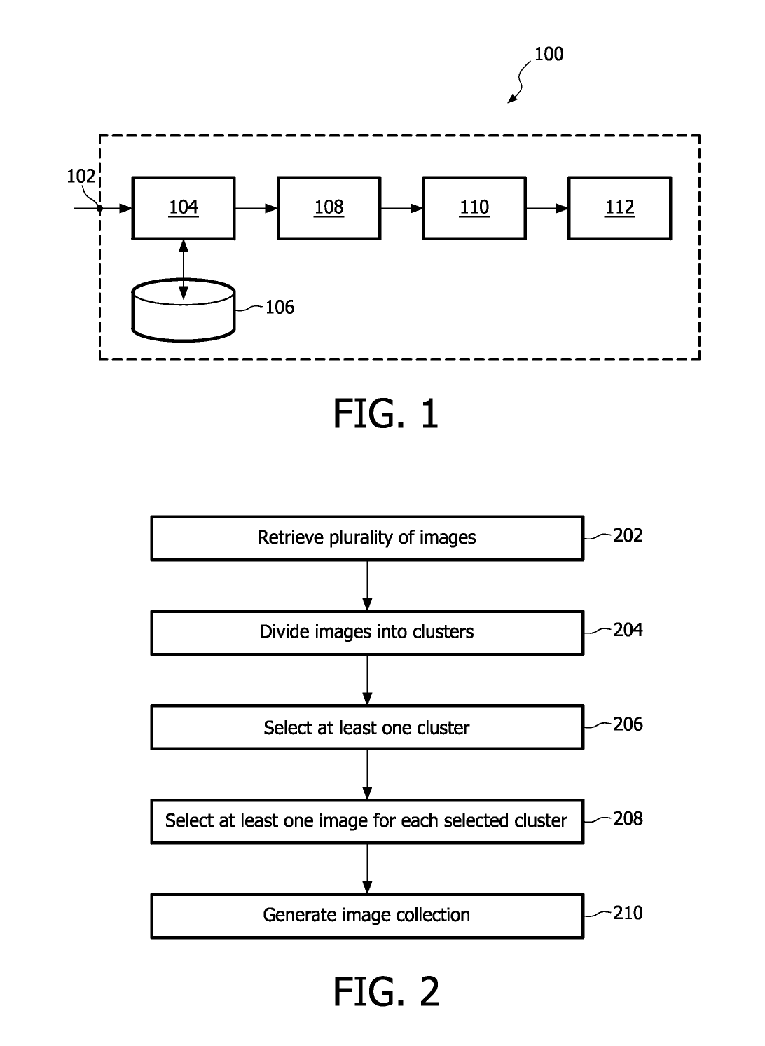

With reference to FIG. 1, the apparatus 100 comprises an input terminal 102 for input into a retrieving means 104. The retrieving means 104 is connected to a storage device 106 for storing a plurality of images. The output of the retrieving means 104 is connected to the input of a divider 108. The output of the divider 108 is connected to the input of a selector 110 and the output of the selector 110 is connected to the input of a display 112.

The retrieving means 104 retrieves a plurality of images from the storage means 106 (step 202). Alternatively, the retrieval means 104 retrieves a plurality of images from an external storage means via the input terminal 102.

The retrieval means 104 inputs the retrieved plurality of images into the divider 108 and the divider 108 divides (step 204) the images into clusters according to a predetermined characteristic of the content of the images (i.e. using content analysis algorithms). For example, the divider 108 divides the images into clusters such that images that have similar characteristics are clustered together. The characteristics may be, for example, luminance, color information such as hue and MPEG 7 dominant color, color distribution features such as MPEG 7 color layout and color structure and/or texture features such as edges. The divider 108 uses these characteristics to define similarities or differences between the images and hence to cluster the images in groups of images that have similar characteristics. The divider 108 also removes blurry images and under/overexposed images such that those images are not included in a cluster.

The divider 108 inputs the clustered images into the selector 110. The selector 110 selects at least one of the clusters based on a number of images in each cluster (step 206). For example, the selector 110 selects clusters that have the largest number of images. The largest clusters (i.e. the clusters that have the largest number of images) are considered to be the most interesting images. This is because if the user takes multiple images from a specific object or event, that object or event is likely to be of high interest to the user, while isolated images are less likely to be of interest.

The number of clusters selected by the selector 110 may be a predetermined number. For example, the predetermined number of clusters may be a number chosen by a user. For example, if the user wants n pages in the image collection, the selector 110 selects the largest n clusters such that each of these clusters will later be displayed on a single page. The user's choice of the number of clusters may, for example, depend on the size of image collection that the user desires.

Alternatively, the number of clusters selected may be based on a distribution of numbers of images in each cluster. For example, there may be only a few clusters that are considered to be largest clusters (i.e. clusters that have over a certain number of images), in which case the selector 110 will select only those few clusters.

The selector 110 then selects, for each selected cluster, at least one image on the basis of a predetermined criterion (step 208). In other words, the selector 110 decides how many images are to be used. For example, the selector 110 selects a number of images from each cluster, the number of images being determined on the basis of the variation within the cluster. This can be achieved by the selector 110 using the information from the clustering results. For example, the selector 110 uses the variation between the characteristics of the images within a cluster to determine the number of images to select. It follows that images within the same cluster will be similar and so images whose characteristics differ the most will be more desirable to select since if the variation between the characteristics of the images is too small, images will be almost exactly the same and it is undesirable to select such images. As an example, if the variation in the cluster is very small, the selector 110 selects one image; if the variation in the cluster is not too small, the selector 110 selects two images; and so on such that the larger the variation in the cluster, the more images the selector 110 selects. This example is used purely for illustrative purposes and any number of similar strategies may be used.

Alternatively, the selector 110 selects a number of images from each cluster, the number of images being determined on the basis of the number of images in the cluster. If there are a large number of images in a selected cluster, the selector 110 selects more images than it would if there were a smaller number of images in the selected cluster. For example, if the cluster contains less than four images, the selector 110 selects one image; if the cluster contains between four and seven images, the selector 110 selects two images; if the cluster contains eight or more images, the selector 110 selects three images and so on. This example is used purely for illustrative purposes and any number of similar strategies may be used.

The selector 110 may, alternatively, use both techniques to select a number of images from each cluster. In this case, the selector 110 selects a number of images from each cluster the number of images being determined on the basis of the number of images in the cluster and also on the basis of the variation within the cluster. If the cluster has a large number of images and if the variation within the cluster is relatively large, the selector 110 selects a larger number of images from the cluster.

In addition to determining the number of images to select from each cluster, the selector 110 also decides which photos to select. For example, if the number of images to select was determined to be one image, the selector 110 selects the image closest to a centroid of the cluster. The centroid of a cluster refers to a representation (in terms of features) of, for example, the average of the images within the cluster. Since some features are non-linear, it is not possible to use the geometrical centroid. Instead, some features are described in terms of histograms. In this case, the selector 110 adds the histograms of the images and divides by the number of images. However, MPEG 7 dominant color, for example, gives a list of up to eight colors (with percentages and variance) that are representative for an image. It is therefore difficult to define the average for such a descriptor. Alternatively, to create a representation for this feature for the centroid of a cluster the selector 110 may determine the average of MPEG 7 dominant color descriptor using a method such as that described in WO2008/047280.

Alternatively, if the number of images to select was determined to be more than one image, the selector 110 selects at least one pair of images that are furthest apart within the cluster (i.e. the two images whose characteristics differ the most). For example, if the number of images to select was determined to be two images, the selector 110 selects the two images that are furthest apart within the cluster (i.e. the two images that have the most variation between their characteristics). The selector 110 may determine which two images are furthest apart within the cluster. This may be based on, for example, a distance measurement such that images that are dissimilar (i.e. that differ the most) are selected. Also, if the number of images to select was determined to be three images, the selector 110 selects the image closest to the centroid of the cluster as well as the two images that are furthest apart and so on. This method therefore avoids a situation where images that are too much alike are chosen. These examples are used purely for illustrative purposes and any number of similar strategies may be used.

Alternatively, or in addition, the selector 110 may use face detection to select more images that contain people. A user may be provided the opportunity to give preferences making it possible for the user to make changes to the clusters. For example, if a user prefers people to be present in the images, the selector 110 uses face detection to select those images that contain people.

The selector 110 inputs the images selected from each cluster into the display 112 and the display 112 generates an image collection comprising these selected images (step 210). The display 112 generates the image collection such that it contains pages, with each page comprising at least one of the selected images. The display 112 may display the images on the page randomly, with some images larger than others, and may choose the positions of the images arbitrarily. The display 112 may display the image collection as a photo album in which the images are presented on a number of pages that can be printed or, alternatively, as a slide show in which the images are presented on a number of slides that can be viewed on, for example, a computer or television screen. Further, the display 112 may display very similar images in a stop motion image or stitch images to create a panoramic view, with wide images being displayed on two consecutive pages.

The display 112 generates the pages in an order based on features that have been extracted from the images included on each page. These features may be, for example, the date on which the pictures were taken which can be extracted from, for example, Exchangeable Image File Format (EXIF) data. The display 112 generates the pages in an order based on the date of one of the images on each of the pages. So, for example, if each page includes images from a certain cluster, the display 112 generates the pages in an order in which the photos were taken since images in the same cluster are likely to have been taken around the same time. The display 112 may, in addition to displaying certain images on each page, display textual information such as the date that each image was taken, the place where each image was taken etc on each page.

The display 112 also generates a background based on information extracted from the selected images included on each page. The display 112 generates a background based on information extracted from the images. For example, the display 112 may use the MPEG 7 dominant color descriptor or any other kind of algorithm to determine which color is dominant in the images or in the cluster of images and then generate a background using this dominant color. In certain cases this will result in a dark background which may not be desirable and so, alternatively, the display 112 may base the background on the light source entering the image. If the light source is not obvious, then the display 112 bases the background on one of the brighter dominant colors in the image.

If the display 112 has generated a background color, the pages may, alternatively, be ordered based on the background color. For example, the display 110 chooses an arbitrary starting point on a hue circle and generates the pages in an order according to the background color with respect to the hue circle. This approach gives a visually very attractive effect since the difference in color from one page to the next is very smooth.

It is possible for the user to manually change the image collection even after it has been generated. For example, if the user is not happy with a specific page, the user can always make changes to that page. However, since the image collection is generated fully automatically using a variety of techniques that predict the images that will be of most interest to the user to include in the image collection and since the image collection is generated in a form that is visually appealing to the user, it is likely that the user will feel a minimum need to adapt the generated image collection.

Although an embodiment of the present invention has been illustrated in the accompanying drawings and described in the foregoing detailed description, it will be understood that the invention is not limited to the embodiment disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of generating an image collection, said image collection comprising a plurality of images, the method comprising the steps of:
retrieving (202) a plurality of images;
dividing (204) the images into clusters according to a predetermined characteristic of the content of said images;
selecting (206) at least one of the clusters based on a number of images in each cluster;
for each selected cluster, selecting (208) at least one image on the basis of a predetermined criterion; and
generating (210) an image collection comprising said selected images.

2. A method according to claim 1, wherein the step of selecting at least one of the clusters comprises selecting clusters having the largest number of images.

3. A method according to claim 2, wherein the step of selecting at least one of the clusters comprises selecting a predetermined number of clusters having the largest number of images.

4. A method according to claim 2, wherein the step of selecting at least one of the clusters comprises selecting a number of clusters having the largest number of images, the number of clusters being based on a distribution of numbers of images in each cluster.

5. A method according to claim 1, wherein the step of dividing the images into clusters comprises clustering images that have similar characteristics.

6. A method according to claim 1, wherein the step of selecting at least one image on the basis of a predetermined criterion comprises selecting a number of images from each cluster, the number of images being determined on the basis of the variation within the cluster and/or on the basis of the number of images in the cluster.

7. A method according to claim 6, wherein one image is selected and wherein the step of selecting at least one image comprises selecting the image closest to a centroid of the cluster.

8. A method according to claim 6, wherein more than one image is selected and wherein the step of selecting at least one image comprises selecting at least one pair of images that are furthest apart within the cluster.

9. A method according to claim 1, wherein the step of generating an image collection comprising said selected images comprises generating an image collection comprising a plurality of pages, each page comprising at least one of said selected images.

10. A method according to claim 9, wherein the method further comprises the step of ordering said plurality of pages based on features extracted from the images included on each page.

11. A method according to claim 1, wherein the method further comprises generating a background based on information extracted from said selected images.

12. A computer program product comprising a plurality of program code portions for carrying out the method according to claim 1.

13. Apparatus (100) for generating an image collection, said image collection comprising a plurality of images, the apparatus comprising:
retrieving means (104) for retrieving (202) a plurality of images;
a divider (108) for dividing (204) the images into clusters according to a predetermined characteristic of the content of said images;
a selector (110) for selecting (206) at least one of the clusters based on a number of images in each cluster and for selecting (208) at least one image on the basis of a predetermined criterion for each selected cluster; and
a display (112) for generating (210) an image collection comprising said selected images.
